(19) United States
(12) Patent Application Publication
(10) Pub. No.: US 2024/0169040 A1
(43) Pub. Date: May 23, 2024

(54) BEHAVIORAL BIOMETRICS USING KEYPRESS TEMPORAL INFORMATION

(71) Applicant: PINDROP SECURITY, INC., Atlanta, GA (US)

(72) Inventors: Hrishikesh RAO, Atlanta, GA (US); Ricky CASAL, Atlanta, GA (US); Elie KHOURY, Atlanta, GA (US); Eric LORIMER, Atlanta, GA (US); John CORNWELL, Atlanta, GA (US); Kailash PATIL, Atlanta, GA (US)

(73) Assignee: PINDROP SECURITY, INC., Atlanta, GA (US)

(21) Appl. No.: 18/515,128

(22) Filed: Nov. 20, 2023

Related U.S. Application Data
(60) Provisional application No. 63/427,498, filed on Nov. 23, 2022.

(51) Int. Cl. G06F 21/31

(52) U.S. Cl. CPC G06F 21/316

(57) ABSTRACT

Embodiments include a computing device that executes software routines and/or one or more machine-learning architectures including a neural network-based embedding extraction system that to produce an embedding vector representing a user's behavior's keypresses, where the system extracts the behaviorprint embedding vector using the keypress features that the system references later for authenticating users. Embodiments may extract and evaluate keypress features, such as keypress sequences, keypress pressure or volume, and temporal keypress features, such as the duration of keypresses and the interval between keypresses, among others. Some embodiments employ a deep neural network architecture that generates a behaviorprint embedding vector representation of the keypress duration and interval features that is used for enrollment and at inference time to authenticate users.

### CROSS-REFERENCE TO RELATED APPLICATION

This application claims priority to U.S. Provisional Patent Application No. 63/427,498, filed Nov. 23, 2022, which is incorporated by reference in its entirety.

### TECHNICAL FIELD

This application generally relates to systems and methods for systems and methods for training and deploying machine-learning architectures for authentication and fraud risk assessment of remote contact events (e.g., calls) based upon machine-learning models that model end-user behaviors when interaction with keypads or entering keypresses.

### BACKGROUND

The manner in which users handle and enter information via devices is often unique to them. Behavioral features of user's operating devices, such as keypress speed, keypress pressure, or orientation of handling the device are commonly considered soft biometrics and can be used to authenticate a user or identify a bad actor. Previous systems have focused on primarily two approaches in which data is entered by the users: (1) fixed text in which users have to enter the same keyphrase for enrollment and testing; and (2) free text in which users can enter any keyphrase for enrollment and testing. Although fixed text systems are simple to implement, a limitation is that fixed text requires the user to provide the same keyphrase. This means each user needs to input the exact same keyphrase for enrolling and testing, which creates many instances in which the keyphrase is vulnerable or reproducible by bad actors. The risks of fixed text systems are that the system can learn to identify the keyphrase rather than the users themselves, in which a system that evaluates the keyphrase would falsely authenticate the bad actor. On the other hand, a free text system does not impose any such restrictions. Prior approaches implemented long keypress sequences of characters or numbers to be entered by the user. But this is long, unwieldly, and challenging for end-users to employ and resource intensive for authenticating users with low latency.

### SUMMARY

Disclosed herein are systems and methods capable of addressing the above-described shortcomings and may also provide any number of additional or alternative benefits and advantages. Embodiments include a computing device that executes software routines and/or one or more machine-learning architectures providing a means for authenticating end-users according to keypress features. The embodiments described herein include computing systems that implement a machine-learning architecture including a neural network-based embedding extraction system that employs a free text paradigm, but only requires a limited number of sequences (9 digits) to produce a behavior embedding vector for the keypress features that the system references later for authenticating users. Embodiments may extract and evaluate keypress features, such as keypress sequences, keypress pressure or volume, and temporal keypress features, such as the duration of keypresses and the interval between keypresses, among others. Some embodiments employ a deep neural network architecture that generates a behaviorprint embedding vector representation of the keypress duration and interval features that is used for enrollment and at inference time to authenticate users.

As an example, in a contact center's interactive voice response (IVR) system, there are often challenge prompts provided to the user to enter information to authenticate themselves or to navigate an IVR menu. The system may receive keypress data in the form of dual-tone multi-frequency (DTMF) tone information. The DTMF tone information is received from the IVR system with timestamps and the tone, indicating a time that a key was pressed. The system can use the keypress data to compute, extract, or otherwise generate the keypress features for a given contact (e.g., call), such as keypress durations and intervals between keypresses. The system may extract an enrolled behaviorprint embedding vector from the keypress data at enrollment and authenticate users based on a cosine distance from an inbound behaviorprint embedding vector extracted from inbound keypress data from the same or different IVR system at inference time.

In some embodiments, a computer-implemented method comprises obtaining, by a computer, enrollment contact data for an enrollee including enrollment keypress data for an enrollment contact event; generating, by the computer, a plurality of enrollment keypress features using the keypress data of the enrollment contact data, the plurality of enrollment keypress features including one or more temporal keypress features; extracting, by a computer, an enrolled behaviorprint vector for the enrollee based upon the plurality of enrollment keypress features, including the one or more enrollment temporal keypress features; generating, by the computer, a plurality of inbound keypress features using inbound keypress data of an inbound contact data, the plurality of inbound keypress features including one or more inbound temporal keypress features; extracting, by a computer, an inbound behaviorprint vector for an inbound user based upon the plurality of inbound keypress features, including the one or more inbound temporal keypress features; and authenticating, by the computer, the inbound user as the enrollee in accordance with an authentication score based upon a distance between the enrolled behaviorprint vector and the inbound behaviorprint vector.

A temporal keypress feature of the enrollment temporal keypress features or the inbound temporal keypress features may include at least one of a keypress duration or a keypress interval between successive keypress.

A computer may obtain inbound keypress data including the inbound keypress features for the inbound contact event via a set of one or more keypress responses corresponding to a set of one or more prompts of an interactive voice response device or program.

The computer may obtain the inbound keypress data as one or more dual-tone multi-frequency (DTMF) tones from the interactive voice response device or program.

The computer may obtain the enrollment contact data for the enrollee including the enrollment keypress data for a plurality of enrollment contact events. The computer extracts the enrolled behaviorprint vector for the enrollee based upon the plurality of enrollment keypress features for the plurality of enrollment contact data events.

The computer may generate a predicted age for the inbound user based upon the inbound temporal keypress features. The computer further authenticates the inbound user as the enrollee based upon comparing the predicted age for the inbound user and an expected age of the enrollee.

The computer may generate a predicted gender for the inbound user based upon the inbound keypress features. The computer further authenticates the inbound user as the enrollee based upon comparing the predicted gender for the inbound user and an expected gender of the enrollee.

The computer may extract a robocall behaviorprint vector associated with one or more robocalls based upon a plurality of robocall keypress features of a plurality of robocall contact events, including the one or more robocall temporal keypress features. The computer may generate a robocall prediction score associated with the inbound contact event based upon a distance between the inbound user behaviorprint vector and the robocall behaviorprint vector.

Extracting the robocall behaviorprint vector may include obtaining, by the computer, a robocall label indicating that a prior contact event is a robocall contact event.

The computer may obtain training contact data for enrollment keypress data for a plurality of training contact events. The computer may generate a plurality of training keypress features using the training keypress data of the training contact data, the plurality of training keypress features including one or more training temporal keypress features. The computer may extract a training behaviorprint vector for the training contact event based upon the plurality of training keypress features, including the one or more training temporal keypress features. The computer may generate a predicted output score by applying a machine-learning architecture on the training behaviorprint. The computer may update one or more hyperparmeters of the machine-learning architecture according to a loss function determined based upon a distance between the predicted output score and an expected output score.

In some embodiments, a system comprises one or more computers comprising one or more processors. A computer comprises a processor configured to obtain enrollment contact data for an enrollee including enrollment keypress data for an enrollment contact event; generate a plurality of enrollment keypress features using the enrollment keypress data of the enrollment contact data, the plurality of enrollment keypress features including one or more enrollment temporal keypress features; extract an enrolled behaviorprint vector for the enrollee based upon the plurality of enrollment keypress features, including the one or more enrollment temporal keypress features; generate a plurality of inbound keypress features using inbound keypress data of an inbound contact data, the plurality of inbound keypress features including one or more inbound temporal keypress features; extract an inbound behaviorprint vector for an inbound user based upon the plurality of inbound keypress features, including the one or more inbound temporal keypress features; and authenticate the inbound user as the enrollee in accordance with an authentication score based upon a distance between the enrolled behaviorprint vector and the inbound behaviorprint vector.

A temporal keypress feature, of the enrollment temporal keypress features or the inbound temporal keypress features, may include at least one of a keypress duration or a keypress interval between successive keypress.

The computer may be further configured to obtain inbound keypress data including the inbound keypress features for the inbound contact event. The computer may obtain the inbound keypress data via a set of one or more keypress responses corresponding to a set of one or more prompts of an interactive voice response device or program.

The computer may obtain the inbound keypress data as one or more dual-tone multi-frequency (DTMF) tones from the interactive voice response device or program.

The computer may be further configured to obtain the enrollment contact data for the enrollee including the enrollment keypress data for a plurality of enrollment contact events. The computer extracts the enrolled behaviorprint vector for the enrollee based upon the plurality of enrollment keypress features for the plurality of enrollment contact data events.

The computer may be further configured to generate a predicted age for the inbound user based upon the inbound temporal keypress features. The computer further authenticates the inbound user as the enrollee based upon comparing the predicted age for the inbound user and an expected age of the enrollee.

The computer may be further configured to generate a predicted gender for the inbound user based upon the inbound keypress features. The computer further authenticates the inbound user as the enrollee based upon comparing the predicted gender for the inbound user and an expected gender of the enrollee.

The computer may be further configured to extract a robocall behaviorprint vector associated with one or more robocalls based upon a plurality of robocall keypress features of a plurality of robocall contact events, including the one or more robocall temporal keypress features; and generate a robocall prediction score associated with the inbound contact event based upon a distance between the inbound user behaviorprint vector and the robocall behaviorprint vector.

When extracting the robocall behaviorprint vector, the computer may be further configured to obtain a robocall label indicating that a prior contact event is a robocall contact event.

The computer may be further configured to obtain training contact data for enrollment keypress data for a plurality of training contact events; generate a plurality of training keypress features using the training keypress data of the training contact data, the plurality of training keypress features including one or more training temporal keypress features; extract an training behaviorprint vector for the training contact event based upon the plurality of training keypress features, including the one or more training temporal keypress features; generate a predicted output score by applying a machine-learning architecture on the training behaviorprint; and update one or more hyperparmeters of the machine-learning architecture according to a loss function determined based upon a distance between the predicted output score and an expected output score.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of a system for receiving and analyzing call data received during contact events, according to an embodiment.

FIG. 2 shows operations of an example method for training, developing, and deploying a machine-learning architecture for evaluating fraud risk or authenticating contact events, according to an embodiment.

FIG. 3 shows operations of an example method for deploying a machine-learning architecture for performing passive authentication and passive enrollment of behaviorprint embedding vectors, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Described herein are systems and methods for processing various types of contact data associated with contact events (e.g., phone calls, VOIP calls, remote access, webpage access) for authentication and risk management. The contact data may include audio signals for speakers, software or protocol data, and inputs received from the end-user, among others. The processes described herein manage the types of data accessible to and employed by various machine-learning architectures that extract various types of contact data (e.g., call audio data, call metadata) from contact events and output authentication or risk threat determinations.

Embodiments include a computing system having computing hardware and software components that actively or passively analyze contact data obtained from contact events to determine fraud risk scores or authentication scores associated with the contact events, end-users, or end-user devices. Optionally, the system actively or passively enrolls the end-users or end-user devices into an enrolled profile. The system receives various types of contact data from end-user devices during contact events (e.g., phone calls). The system may capture and analyze various types of data, including AI/ML-generated embedding vectors (e.g., voiceprints, deviceprints, behaviorprints). There is an ongoing industry push into the area of risk-based or probability-based authentication to authenticate users via voice biometrics, behavioral biometrics, phone number validation, metadata (e.g., SIP signaling), and among other types of data.

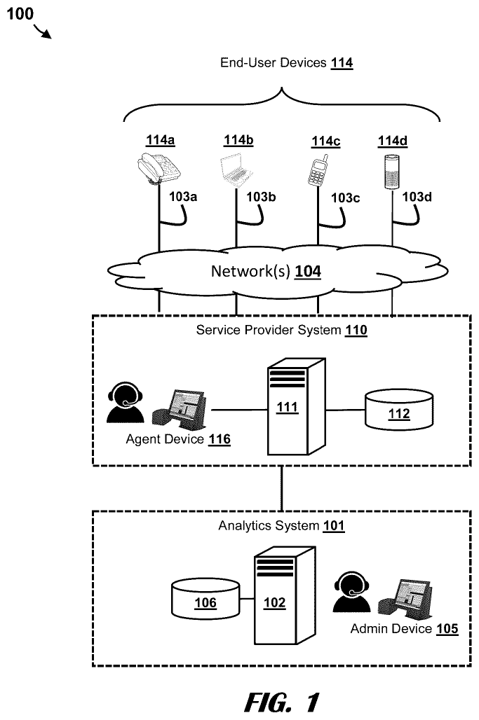

FIG. 1 shows components of a system 100 for receiving and analyzing call data received during contact events. The system 100 comprises any number of end-user devices 114a-114d (collectively referred to as “end-user devices 114” or an “end-user device 114”) and enterprise infrastructures 101, 110, including an analytics system 101 and one or more provider systems 110. The analytics system 101 includes analytics servers 102, analytics databases 104, and admin devices 105. The service provider systems 110 may include provider servers 111, provider databases 112, and agent devices 116. The various hardware and software components of the system 100 may communicate with one another via one or more networks 104, through various types of communication channels 103a-103d (collectively referred to as “channels 103” or a “channel 103”).

Embodiments may comprise additional or alternative components or omit certain components from those of FIG. 1, and still fall within the scope of this disclosure. As an example, it may be common for the system 100 to include multiple call center systems 110 or the analytics system 101 to include multiple analytics servers 102. Embodiments may include or otherwise implement any number of devices capable of performing the various features and tasks described herein. For example, the system 100 of FIG. 1 shows the analytics server 102 as a distinct computing device from the analytics database 106, though in some embodiments, the analytics database 104 may be integrated into the analytics server 102.

The one or more networks 104 of the system 100 includes various hardware and software components of one or more public or private networks that interconnect the various components of the system 100 and host or conduct audio and voice communications originated at the end-user devices 114. Non-limiting examples of such networks 104 may include: Local Area Network (LAN), Wireless Local Area Network (WLAN), Metropolitan Area Network (MAN), Wide Area Network (WAN), and the Internet. The communication over the network 104 may be performed in accordance with various communication protocols, such as Transmission Control Protocol and Internet Protocol (TCP/IP), User Datagram Protocol (UDP), and IEEE communication protocols. Likewise, the end-user devices 114 may communicate with callees (e.g., provider systems 110) via telephony and telecommunications protocols, hardware, and software of the networks 104, capable of hosting, transporting, and exchanging audio data associated with telephony-based calls. Non-limiting examples of telecommunications hardware of the networks 104 may include switches and trunks, among other additional or alternative hardware used for hosting, routing, or managing telephone calls, circuits, and signaling. Non-limiting examples of software and protocols of the networks 104 for telecommunications may include SS7, SIGTRAN, SCTP, ISDN, and DNIS among other additional or alternative software and protocols used for hosting, routing, or managing telephone calls, circuits, and signaling. Various different entities manage or organize the components of the telecommunications systems of the networks 104, such as carriers, networks, and exchanges, among others.

The end-user devices 114 (sometimes referred to as “caller devices”) may be any communications or computing devices that the caller operates to access the services of the service provider system 110 through the various communications channels 103. The end-user may place the call to the service provider system 110 through a telephony network or through a software application executed by the end-user device 114. Non-limiting examples of end-user devices 114 may include landline phones 114a, mobile phones 114b, calling computing devices 114c, or edge devices 114d. The landline phones 114a and mobile phones 114b are telecommunications-oriented devices (e.g., telephones) that communicate via certain channels 103 for telecommunications. The end-user devices 114, however, are not limited to the telecommunications-oriented devices or channels. For instance, in some cases, the mobile phones 114b may communicate via channels 103 for computing network communications (e.g., the Internet). The end-user device 114 may also include an electronic device comprising a processor and/or software, such as a calling computing device 114c or edge device 114d implementing, for example, voice-over-IP (VOIP) telecommunications, data streaming via a TCP/IP network, or other computing network channel. The edge device 114d may include any Internet of Things (IoT) device or other electronic device for computing network communications. The edge device 114d could be any smart device capable of executing software applications and/or performing voice interface operations. Non-limiting examples of the edge device 114d may include voice assistant devices, automobiles, smart appliances, and the like.

As described herein, the analytics system 101 or service provider systems 110 may receive calls or other forms of contact events from the end-user devices 114 via one or more channels 103, which include various forms of contact channels conducted over the one or more networks 104. The channels 103 facilitate communications between the provider system 110 and the end-user device 114, whenever the user accesses and interacts with the services or devices of the provider system 110 and exchanges various types of data or executable instructions. The channels 103 allow the end-user to access the services, service-related data, and/or user account data hosted by components of the provider system 110, such as the provider servers 111. Each channel 103 includes hardware and/or software components for hosting and conducting the communication exchanges (e.g., telephone calls) between the provider system 110 and the end-user device 114 corresponding to the channel 103.

In some cases, the user operates a telephony communications device, such as a landline phone 114a or mobile device 114c, to interact with services of the provider system 110 by placing a telephone call to a call center agent or interactive voice response (IVR) system hosted by the enterprise telephony server 111a. The user operates the telephony device (e.g., landline phone 114a, mobile device 114c) to access the services of the provider system 110 via corresponding types of telephony communications channels, such as the landline channel 103a (for the landline phone 114a) or the mobile telephony channel 103c (for the mobile device 114c).

In some cases, the end-user device 114 includes a data-centric computing device (e.g., computing device 114b, mobile device 114c, IoT device 114d) that the user operates to place a call (e.g., VoIP call) to or access the services of the provider system 110 through a data-centric channel 103 (e.g., computing channel 103b, mobile channel 103c, IoT channel 103d), which includes hardware and software of computing data networks and communication (e.g., Internet, TCP/IP networks). For instance, the user operates the computing device 114b or IoT device 114d as a telephony device that executes software-based telephony protocols (e.g., VoIP) to place a software-based telephony call through the corresponding channel (e.g., computing channel 103b, IoT channel 103d) to the provider server 111 or analytics server 102. Notably, certain channels 103 of the system 100 represent data channels in some circumstances, but represent telephony channels in other cases. For example, the end-user executes software on the computing device 114b that accesses a web-portal or web-application hosted on the provider server 111, such that the computing channel 103b represents a data-centric channel carrying the data packets for the data service-related services. As another example, the end-user executes a telephony software (sometimes referred to as a “softphone”) of the computing device 114b or mobile device 114c to place a telephone call received at the provider server 111, such that the computing channel 103b or mobile channel 103b represents a telephony channel carrying the data for the telephony-related services.

The call analytics system 101 and the call center system 110 represent network infrastructures 101, 110 comprising physically and logically related software and electronic devices managed or operated by various enterprise organizations. The hardware and software components of each network system infrastructure 101, 110 are configured to provide the intended services.

An end-user facing enterprise organization (e.g., corporation, government entity, university) operates the service provider system 110 to service calls or web-based interactions with the end users via the various communication channels 103. The service provider system 110 includes provider server 111 or other computing device that executes various operations related managing inbound calls. These operations include receiving or generating various forms of call data (or other contact data) and transmitting the call data to the analytics system 101. At the analytics system 101, the analytics server 102 performs the analytics operations on the contact data.

An analytics service operates the analytics system 101 to perform various call analytics operations on behalf of the enterprise's service provider system 110. The analytics operations include, for example, fraud detection and caller authentication. The service provider system 110 comprises various hardware and software components that capture and store various types of contact data (sometimes referred to as “call data” in the example system 100), including audio data or metadata related to the call or other type of contact event received at the service provider system 110. The data may include, for example, audio data (e.g., audio recording, audio segments, acoustic features), caller inputs (e.g., DTMF keypress tones, spoken inputs or responses), caller information, and metadata (e.g., protocol headers, device identifiers) related to particular software applications (e.g., Skype), programming standards (e.g., codecs), and protocols (e.g., TCP/IP, SIP, SS7) used to execute the call via the particular communication channel 103 (e.g., landline telecommunications, cellular telecommunications, Internet). The service provider system 110 is operated by a particular enterprise to offer various services to the enterprise's end-users (e.g., customers, account holders).

Turning to the analytics system 101, the analytics system 101 analyzes the call data (or other contact data) on behalf of, and received from, the service provider systems 110. The analytics system 101 may evaluate the call data to determine or predict fraud risks associated with the contact events (e.g., inbound calls), or authenticate the contact events (e.g., inbound calls). When authenticating a particular contact event, the analytics system 101 may authenticate the end-user, the end-user device 114, the contact event as a whole, or other aspect of the contact event.

The analytics server 102 may be any computing device comprising one or more processors and software, and capable of performing the various processes and tasks described herein. The analytics server 102 may host or be in communication with the analytics database 106, and receives and processes the contact data (e.g., audio recordings, metadata) received from the one or more service provider system 110. Although FIG. 1 depicts a single analytics server 102, the analytics server 102 may include any number of computing devices. In some cases, the computing devices of the analytics server 102 may perform all or sub-parts of the processes and functions of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the service provider system 110 (e.g., provider servers 111).

When the provider server 111 (e.g., enterprise telephony server 111a) receives contact data from the end-user device 114 during a contact event (e.g., call via channel 103 for carrying telephony communications), the provider server 111 transmits an analytics request or authentication request to the analytics server 102, instructing the analytics server 102 to invoke various analytics operations on the call data received from the end-user device 114 for a given communication channel session (e.g., inbound call received via telephony channel). The analytics server 102 executes software programming for analyzing contact event data (e.g., call data) for end-user authentication and fraud risk scoring. The software programming includes machine-learning software routines organized as a machine-learning architecture having various one or more models or functions defining operational engines and/or components of the machine-learning architecture. The software routines may define a machine-learning architecture and sub-components of the machine-learning architecture (e.g., machine-learning models, sub-architectures), such as a Gaussian Mixture Matrix (GMM), neural network (e.g., convolutional neural network (CNN), deep neural network (DNN)), and the like. The machine-learning architecture may include functions, layers, parameters, and weights for performing the various operations discussed herein, including computing keypress features, extracting embeddings (e.g., behaviorprints, voiceprints, device-prints), and end-user authentication or fraud risk scoring. Certain operations may include, for example, authentication (e.g., user authentication, speaker authentication, end-user device 114 authentication), end-user recognition, and risk detection, among other operations.

For instance, the software functions of the analytics server 102 includes machine-learning models, functions, or layers for generating and analyzing user behaviorprints among other types of feature embeddings, and for performing any number of downstream call processing operations. Embeddings may include a behaviorprint (e.g., a feature vector generated from user's behavior-related features as a mathematical representation of the user's behaviors during contact events), voiceprint (e.g., a feature vector generated from speaker-related features as a mathematical representation for speaker voice biometrics), deviceprint (e.g., a feature vector generated from device-related features as a mathematical representation for device-identifying information), and/or a spoofprint (e.g., a feature vector generated from spoofed features as a mathematical representation for indicators of spoofed users or devices). For ease of description, the analytics server 102 is described as executing a single machine-learning architecture having a neural network architecture for implementing behavior-printing, including neural network layers for extracting speaker-independent feature vectors and embeddings, though various types of machine-learning model may be employed and/or multiple machine-learning architectures could be employed in some embodiments.

In some implementations, for example, the analytics server 102 includes software programming for one or more embedding extraction engines of the machine-learning architecture. The embedding extraction engine includes operations for extracting certain feature vectors from one or more input and implements machine-learning models trained to extract the feature vectors using corresponding types of features. The analytics server 102 may extract certain types of features using the contact data from the end-user device 114. Using the extracted features, the embedding extractor (or other components of the machine-learning architecture) may extract feature vectors representing aspects of the end-user (e.g., speaker) or end-user device 114. When authenticating an end-user or determining the risk of a particular contact event, the machine-learning architecture may compare expected vectors against observed vectors to generate similarity scores or risk scores by computing, for example, a cosine distance between an expected vector and an observed or predicted vector. The analytics server 102 authenticates or permits the call when the similarity score (e.g., behaviorprint similarity score, voiceprint similarity score, deviceprint similarity score) satisfies a recognition threshold or when the risk score satisfies a risk threshold.

For example, the provider server 111 (or other IVR device) may execute IVR software of the service provider system 110 that sends automated prompts to, and receives end-user spoken or keypress-based responses from, the end-user devices 114 during contact events, when the end-user interacts with the IVR software hosted by the provider server 111. The analytics server 102 may receive contact information related to the user inputs and evaluate the content of the user responses to the IVR prompts and/or behavior biometrics (e.g., keypress data) that could be used to identify the end-user (e.g., the rate at which the user provides the responses), which may referred to as a “behaviorprint.” Using this user input information, the analytics server 102 extracts the behaviorprint as a vector representing the user's behavior when interacting with the IVR software of the provider server 111. Non-limiting examples embodiments of such behaviorprints and a machine-learning architecture configured to generate and process behaviorprints may be found in U.S. Pat. No. 9,883,040 and U.S. application Ser. No. 17/231,672, which are incorporated by reference herein.

As another example, the analytics server 102 may receive device-related data for the end-user device 114, such as a contact channel, a type of end-user device 114, an automatic number identification (ANI), phone number, IP address, MAC address, codec used to transmit audio data, and software executed by the end-user device 114, among others. Using this data, the machine-learning architecture may extract a “deviceprint” that uniquely identifies the particular end-user device 114. The analytics server 102 may extract the deviceprint as a vector representing the particular end-user device 114. Non-limiting examples embodiments of such deviceprints and a machine-learning architecture configured to generate and process deviceprints may be found in U.S. Pat. Nos. 10,325,601 and 11,019,203, and U.S. application Ser. No. 16/992,789, each of which is incorporated by reference herein.

As another example, the analytics server 102 receives the input audio signal, along with the other types of inputted data. The input audio signal may include a speaker's speech signal and, in some cases, various types of noise. The machine-learning architecture extracts and evaluates speaker features as a speaker voice biometric (referred to as a “voiceprint” or “speaker vector”) uniquely identifying a particular speaker. The analytics server 102 extracts features from the input audio signal, generates a vector using the extracted features, and extracts the “voiceprint” for the speaker using one or more vectors generated for one or more speaker audio signals. Non-limiting examples embodiments of such voiceprints and a machine-learning architecture configured to generate and process voiceprints may be found in U.S. Pat. Nos. 10,325,601 and 11,019,203, and U.S. application Ser. No. 17/165,180, each of which is incorporated by reference herein.

The analytics server 102 and the machine-learning architecture operates logically in several operational phases, including a training phase, an enrollment phase, and a deployment phase (sometimes referred to as a “test” phase or “inference” phase), though some embodiments need not perform the enrollment phase. The inputted contact data processed by the analytics server 102 and the machine-learning architecture include training contact data (e.g., training call data, training keypress data, training audio signals containing DTMF tones) of training contact events, enrollment contact data (e.g., enrollment call data, enrollment keypress data, enrollment audio signals containing DTMF tones) for enrollment contact events, and inbound contact data (e.g., inbound call data, inbound keypress data, inbound audio signals containing DTMF tones) for inbound contact events (during the deployment phase). The analytics server 102 applies the machine-learning architecture to each type of inputted contact data during the corresponding operational phase.

During a training phase, the analytics server 102 receives training contact data (e.g., training audio signals, training keypress data) or generates various simulated or synthetic training data based on augmentation functions, which may include degraded copies of training contact data. The analytics server 102 applies the layers of the various machine-learning architectures to generate one or more predicted outputs according to the operational layers of the particular component of the machine-learning architecture. Loss layers or another function of the machine-learning architectures determine a level of error (e.g., one or more similarities, cosine distances) between the predicted output score and training labels or other data indicating the expected output. The loss layers (or another aspect) of the machine-learning architecture adjusts the hyper-parameters until the level of error for the predicted outputs (e.g., predicted behaviorprint, predicted voiceprint, predicted deviceprint) satisfy a threshold level or error with respect to expected outputs (e.g., expected behaviorprint, expected voiceprint, expected deviceprint). The analytics server 102 then stores the hyper-parameters, weights, or other terms of the particular machine-learning architecture into the analytics database 106, thereby “fixing” the particular component of the machine-learning architecture and one or more models.

During an enrollment phase, the analytics server 102 implements an active enrollment operation. An enrollee-user, such as an end-consumer of the service provider system 110, provides (to the analytics system 101 or service provider system 110) bona fide enrollee data (e.g., enrollment keypress data, enrollment audio signals, enrollment device data). For instance, the enrollee could provide responsive keypress inputs to various interactive voice response (IVR) prompts generated by IVR software executed by the call center server 111 via the telephone channel. The responsive inputs could include, for example, credentials (e.g., username, password, passcode) or menu selections. The analytics server 102 applies the various components of the machine-learning architecture to develop models representing the enrollee characteristics (e.g., keypress behaviors). For example, the machine-learning architecture extracts one or more enrollee vector embeddings (e.g., enrollee voiceprint, enrollee deviceprint, enrollee behaviorprint) and algorithmically combines the enrollee vector embeddings to generate an enrolled vector embedding (e.g., enrolled voiceprint, enrolled deviceprint, enrolled behaviorprint). In some embodiments, the analytics server 102 implements a passive enrollment operation. When implementing passive enrollment, the machine-learning architecture may identify and enroll new enrollee-users on the fly, in which the analytics server 102 automatically captures certain enrollment data to enroll newly distinguished enrollee-users without requiring active interactions from the particular enrollee-user. In some implementations, the machine-learning architecture performs continuous passive enrollment operations in which the analytics server 102 may capture and re-evaluate enrollment data on an ongoing basis, such that the analytics server 102 continuously updates the information for enrolled users (e.g., keypress features, enrolled behaviorprint). Non-limiting example embodiments of passive and continuous enrollment may be found in U.S. application Ser. No. 17/231,672, which is incorporated by reference herein.

During the deployment phase, the analytics server 102 receives the inbound contact event data for an inbound user, from the provider server 111. The analytics server 102 applies the various components of the machine-learning architecture to generate or extract an inbound features and extract an inbound vector embedding (e.g., inbound behaviorprint, inbound voiceprint, inbound deviceprint) for the inbound user, compute one or more scores (e.g., similarity score, authentication score, fraud risk score) by computing a cosine distance between an inbound behaviorprint vector embedding (among other embedding vectors) and the previously generated enrollee behaviorprint vector embedding. The analytics server 102 may then determine whether the one or more scores computed for the inbound behaviorprint vector is within one or more corresponding threshold scores. The analytics server 102 authenticates the inbound user as being the enrolled user by verifying whether the one or more similarity scores satisfy the corresponding similarity threshold scores.

In some embodiments, the analytics server 102 evaluates the one or more similarity scores and similarity thresholds in determining an authentication score. And in some embodiments, the analytics server 102 may determine the authentication score using additional metric data to, for example, determine the authentication score, calculate a final authentication score, determine authentication or confidence levels, or other potential operations for determining whether the authenticate the inbound user.

The contact event data received from the end-user device 114 includes timestamps that the analytics server 102 may reference in determining temporal characteristics. For instance, the IVR software may provide keypress data containing timestamps, indicating when success keypresses were received from the end-user device 114 to enter a menu selection or enter user credentials. Non-limiting examples may include the rate at which keypresses were entered, the amount of delay time between IVR prompts and keypresses, an interval of time for the keypresses, and a duration of time of a keypress amount of time, among other types of behavior features or keypress features.

In some cases, the analytics server 102 may receive keypress data indicating keypress features from the provider server 111. Additionally or alternatively, the analytics server 102 may compute certain keypress features using keypress data or other types of contact data. The analytics server 102 may extract, compute, or otherwise generate keypress features from the contact data. The analytics server 102 then extracts a behaviorprint feature vector as a mathematical representation of the end-user's behavior (e.g., keypress speed, sequence, volume) or other types of characteristics of the end-user or end-user device 114. The analytics server 102 applies the machine-learning architecture on the behavior feature vector to determine one or more scores, such as an authentication score or similarity score for the end-user. In some implementations, the contact data includes keypress data in the form of DTMF tones as digital data defined by RFC2833 or other standards, which provides for each keypress to have a timestamp, duration, and volume. The machine-learning architecture or other software programming of the analytics server 102 computes or extracts keypress features using the keypress data of the contact data. For instance, the provider server 111 or analytics server 102 determines or extracts, for example, durations and volumes for each keypress, and calculates time intervals as a time difference between timestamps of each pair of consecutive keypresses. The analytics server 102 may compute these keypress features information or obtain these features from the provider server 111. In some implementations, the analytics server 102 or the provider server 111 may store the keypress features into non-transitory memory of the analytics server 102, the analytics database 106, or the provider database 112. For instance, for a given contact event or end-user, the analytics database 106 may store the durations and intervals as floating point values, and the volume as an integer between 0 and 36, with 0 representing the least attenuated, or “loudest” keypress volume.

The analytics server 102 or provider server 111 may extract data or metadata from the contact data and compute meta-features to includes as additional behavior features in the feature vector. The analytics server 102 or provider server 111 may calculate the meta-features on a set of digits (corresponding to keypress tones) aggregated over a particular call, or a portion of that call (e.g., keypresses entered during one or more legs of IVR navigation, keypresses entered at account entry). In some cases, generating these meta-features includes computing various mathematical operations, such as the mean and standard deviation of all keypress durations in the keypress features of the call.

In some implementations, the analytics server 102 or provider server 111 may extract similar features on the audio portion of each tone. Although DTMF information is usually sent out-of-band (as digital data RFC2833) from the audio channel, a small residual audio often remains. The analytics server 102 may extract similar feature keypress information (or other types of information) as above from the audio channel as well.

The machine-learning architecture may include a neural network architecture for extracting behaviorprint embedding vectors based on behavior features (e.g., keypress features) and determining one or more output scores, such as an authentication score for a user or cosine distance between feature vectors. The neural network architecture extracts and captures keypress features representing the sequential nature of keypress intervals and keypress durations. The neural network architecture may include, for example, a long short-term memory (LSTM) or Gated Recurrent Network (GRU) neural network architecture. The machine-learning architecture may reference the keypress intervals and keypress durations as types of input features (e.g., behavior features, keypress features), which may include, for example, a keypress sequence length of 8 keypresses. The neural network architecture may include LSTM/GRU layers followed by dense layers including an output layer. When generating the one or more scores, or when training the machine-learning architecture, the output layer may implement large-margin cosine loss (LMCL) or Additive Angular Margin Loss (AAML) to compute a distance score and loss or level or error. During training, the analytics server 102 trains a machine-learning model of the neural network architecture with respect to a target variable being, for example, a particular end-user as a training label associated with the particular keypress features or feature vector. In some embodiments, the initial layers of the machine-learning architecture encapsulate the temporal keypress features of the keypress data and the dense layers, followed by the loss function (e.g., LMCL, AAML), and generates representations of the keypress features. The loss function is programmed to produce higher inter-class variance while lowering the intra-class variance.

During training, the analytics server 102 places the machine-learning architecture into a training phase and applies the machine-learning architecture on a training dataset containing a corpus of training contact data for training contact events with end-users. For instance, the analytics database 106 may contain training contact data containing keypress information for any amount (e.g., hundreds, thousands) of users, across any amount (e.g., hundreds, thousands) of training contact events. The keypress information includes any data type representing or indicating multiple keypress entries per user recorded at different timestamps.

In some embodiments, the analytics server 102 applies one or more data augmentation operations on the training data. The analytics server 102 or other computing device of the system 100 (e.g., provider server 111) can perform various pre-processing operations and/or data augmentation operations on the input call data (e.g., training call data, call data, inbound call data). The analytics server 102 may perform the pre-processing operations and data augmentation operations when executing certain machine-learning architecture layers or function, though the analytics server 102 may also perform certain pre-processing or data augmentation operations as a separate operation from the machine-learning architecture (e.g., prior to feeding the input call data into the machine-learning architecture). In some implementations, the analytics server 102 may augment the training data every feature or element, i, in each feature vector, x^{j}, perturbed by an element that is drawn from a normal distribution with the mean and standard deviation computed from the elements of the feature vector, x^{j}:

$${x}_{i}^{′ j} = {x}_{i}^{j} + N ( μ ( {x}^{j} ) , σ ( {x}^{j} ) )$$

In this way, the analytics server 102 computes one or more augmented synthetic training contact events having one or more synthetic training feature vectors as augmented synthetic versions or distorted copies of the feature vector of each training sample point.

At enrollment time, an enrolled behaviorprint embedding vector of an enrollee is computed by applying the trained machine-learning architecture on enrollment contact data of the enrollee. In some cases, if the analytics server 102 extracts multiple enrollment embeddings from prior enrollment contact events, then the analytics server 102 may compute a mean or average of the multiple behaviorprints enrollment embeddings to update and store the behaviorprint embedding vectors. For testing purposes, the inbound behaviorprint embedding vector is extracted from the contact data and computes a cosine similarity with enrolled behaviorprint embedding vector, which indicates, for example, how similar the inbound user's keypress-related inbound behaviorprint embedding vector is to the enrolled behaviorprint embedding vector. The analytics server 102 implements one or more classifier or comparator functions that determine whether the one or more scores (e.g., similarity score, distance) satisfies a threshold score to decide, for example, whether the authenticate the inbound end-user as the enrollee.

In an example operation, a provider server 111 executing an interactive voice response (IVR) software program (or other IVR device executing the IVR software) generates prompts for the end-user to enter information from the end-user device 114, to authenticate themselves or to navigate to a menu for resolution of an issue. The end-user device 114 may submit the dual-tone multi-frequency (DTMF) tone information to the provider server 111. The analytics server 102 may receive the DTMF tone information as keypress data of the contact data. The DTMF tone data may receive either directly from the audio signal from the end-user device 114 to the provider server 111, or from a metadata RTP payload that allows the analytics server 102 to compute, e.g., temporal keypress features using timestamps associated with the DTMF tones, such as the DTMF durations and intervals between keypresses. The analytics server 102 extracts the embedding vectors based on the DTMF tones, which the analytics server 102 uses to to authenticate users who call into the same or different IVR software system.

Beneficially, in some implementations, the keypress information of users navigate through IVR menus or entering personal information can still be authenticated without increasing privacy exposures. For instance, in banking or retail IVR systems, users often user smart devices to submit personal information. As the machine-learning architecture does not need to store personal content information about the keypresses themselves, the keypress may be evaluated for authenticated but the end-user's privacy is maintained.

In some embodiments, the server may perform various downstream operations for computing risk scoring, such as predicting an age or gender based upon the keypress pattern of the inbound behaviorprint embedding vector and comparing the predicted age or gender of the inbound user against the expected age or gender indicated by an enrolled user profile record in a database. In such embodiments, the initial layers of the machine-learning architecture may generate or extract the temporal characteristics of the keypress information. The analytics server 102 may reference the temporal keypress features as early stage features and are useful for other downstream tasks, such as user age recognition. Additional dense layers of the machine-learning architecture are added to the pre-trained initial layers as an age predictor engine or machine-learning model of the machine-learning architecture. The analytics server 102 may fine-tune the age prediction engine using the enrolled user's or training user's known age in the provider database 112 or analytics database 106 as the target expected value. The analytics server 102 trains the age predictor by implementing the with Mean Square Error (MSE) or a similar loss function. In some implementations, the machine-learning architecture may combine these early stage features from other sub-architectures of the machine-learning architecture, such as voiceprint and facial biometrics neural network architectures, to generate a multi-modal DNN architecture, which is also fine-tuned in the same way. In some embodiments, the machine-learning architecture includes a gender prediction engine similar to the age prediction engine. The machine-learning architecture may use the behaviorprint embeddings with keypress features for gender classification. The behaviorprint embeddings or cosine disatnces may be used as input features to a multi-class classifier such as SVM, logistic regression, or a neural network. The classification could be binary, such as Adult/Child classification, Male/Female classification, or 3-class problem of Child/Female/Male classification.

In some embodiments, the analytics server 102 may use the behaviorprint embeddings with keypress features for training and deploying a robocall detection engine in the machine-learning architecture. In some embodiments, the machine-learning architecture extracts the enrolled behaviorprint embeddings with the keypress features and the inbound behaviorprint embeddings with keypress features. The analytics server 102 then applies an anomaly detection algorithm (e.g., isolation forest) on the collection of behaviorprint embeddings with keypress features to detect an instance of the anomalous outlier according to the threshold of the algorithm, such that the analytics server 102 detect a likely robocaller as the inbound end-user.

The analytics database 104 and/or the call center database 112 may be hosted on any computing device (e.g., server, desktop computer) comprising hardware and software components capable of performing the various processes and tasks described herein, such as non-transitory machine-readable storage media and database management software (DBMS). The analytics database 104 and/or the call center database 112 contains any number of corpora of training contact data (e.g., training audio signals, training metadata) that are accessible to the analytics server 102 via the one or more networks.

In some embodiments, the analytics server 102 may employ supervised training to train the certain machine-learning models or sub-architectures of the machine-learning architecture. In such embodiments, the analytics database 104 and/or the call center database 112 contains labels associated with the training contact data or enrollment contact data. The labels indicate, for example, the expected data or expected outputs when the machine-learning architecture is applied to the training contact data or enrollment contact data. The analytics server 102 may also query an external database (not shown) to access a third-party corpus of training contact data. An administrator or agent may operate the admin device 105 or agent device 116 to provide configuration inputs to the analytics server 102, such as a configuring the analytics server 102 to select the training contact data for data records of training contact events having various types of speaker-independent characteristics or metadata, such as behavior features or keypress features. The analytics database 104 stores the configuration inputs received from the admin device 105 or agent device 116 that configure operations of the machine-learning architecture.

The service provider system 110 includes the provider server 111 and agent device 116. The provider server 111 of the provider system 110 executes software processes for interacting with the end-users through the various channels. The processes may include, for example, routing calls to the appropriate agent devices 116 based on an inbound caller's comments, instructions, IVR inputs, or other inputs submitted during the inbound call. The provider server 111 can capture, query, or generate various types of information about the inbound audio signal, the caller, and/or the end-user device 114 and forward the information to the agent device 116. A graphical user interface (GUI) of the agent device 116 displays the information to an agent of the service provider. The provider server 111 also transmits the information about the inbound audio signal to the analytics system 101 to preform various analytics processes on the inbound audio signal and any other audio data. The provider server 111 may transmit the information and the contact data based upon preconfigured triggering conditions (e.g., receiving the inbound phone call), instructions or queries received from another device of the system 100 (e.g., agent device 116, admin device 103, analytics server 102), or as part of a batch transmitted at a regular interval or predetermined time.

The admin device 103 of the analytics system 101 is a computing device allowing personnel of the analytics system 101 to perform various administrative tasks or user-prompted analytics operations. The admin device 103 may be any computing device comprising a processor and software, and capable of performing the various tasks and processes described herein. Non-limiting examples of the admin device 103 may include a server, personal computer, laptop computer, tablet computer, or the like. In operation, the user employs the admin device 103 to configure the operations of the various components of the analytics system 101 or provider system 110 and to issue queries and instructions to such components.

The agent device 116 of the provider system 110 may allow agents or other users of the provider system 110 to configure operations of devices of the provider system 110. For calls made to the provider system 110, the agent device 116 receives and displays some or all of the information associated with inbound audio signals routed from the provider server 111.

The provider server 111 receives an authentication results notification from the analytics server 102, indicating the results of the various operations for evaluating the trustworthiness or riskiness of the end-user device 114 attempting to communicate with the provider system 110. The authentication results include, for example, a confidence score (or threat score) indicating the distance (or similarity) between the enrolled voiceprint (or other types of enrolled vectors, such as deviceprints or behaviorprints) of the end-user.

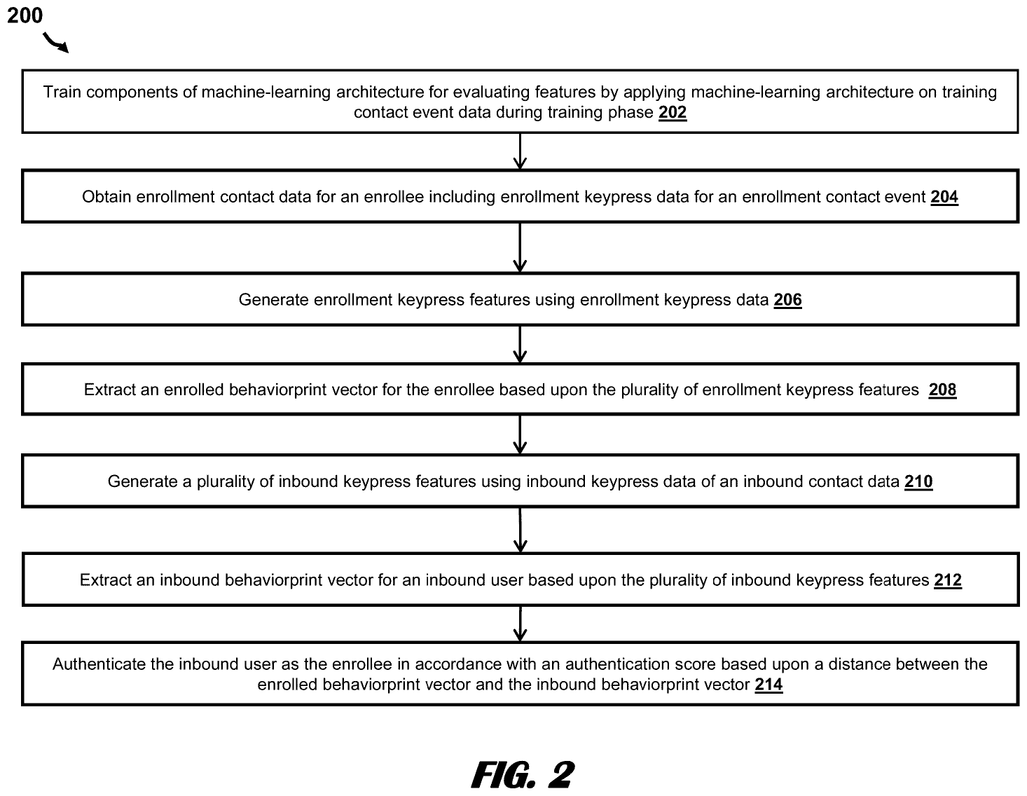

FIG. 2 shows operations of an example method 200 for training, developing, and deploying a machine-learning architecture for evaluating fraud risk or authenticating contact events. Embodiments may include additional, fewer, or different operations than those described in the method 200. The method 200 is performed by a server executing machine-readable software code of a neural network architecture comprising any number of neural network layers and neural networks, though the various operations may be performed by one or more computing devices and/or processors. Although the server is described as generating and evaluating enrollee embeddings, the server need not generate and evaluate the enrollee embeddings in all embodiments.

In operation 202, the server trains a machine-learning architecture for evaluating training features by applying the machine-learning architecture on training contact data during the training phase, where the training contact data includes training keypress data indicating training keypress features, among other potential training behavior features. The server places layers or functions of the machine-learning architecture into a training operational phase in order to train the functions of the machine-learning architecture to, for example, extract features and feature vectors from contact data, determine fraud risks for contact events, or authenticate contact events (e.g., authenticate end-user, authenticate end-user device). During training, the server applies the machine-learning architecture on a corpus of training contact data of the training contact events. The contact data comprises audio recording data (e.g., DTMF tones) or related metadata (e.g., converted data representing IVR software menu selections corresponding to the DTMF tones) for any number of training contact events. The contact data includes any type of data or format indicating an end-user's keypresses, at the end-user device. As an example, in some cases, the contact data includes audio recordings of the DTMF tones corresponding to the keypresses. As another example, the contact data may include metadata indicating the user's keypresses or menu selections that correspond to the keypresses.

For each training event data record, the embedding extraction engine of the machine-learning architecture may extract the keypress features (among other types of features) to extract training feature vectors. Classifier layers of an authentication engine of the machine-learning architecture may output one or more scores (e.g., predicted distance, predicted authentication score) or predicted authentication result. The machine-learning models of the machine-learning architecture (e.g., embedding extractor, authentication engine) may generate the predicted outputs (e.g., predicted training feature vector, predicted classification) for the particular training contact data. One or more post-embedding extraction modeling layers (e.g., classification layers, fully-connected layers, loss layer) of the machine-learning architecture perform a loss function according to the predicted outputs for the training data and labels associated with the training data. The server executes the loss function to determine a level of error of the training feature vectors produced by the modeling layers. The classifier layer (or other layer) adjusts hyper-parameters of the of the machine-learning architecture until the predicted behaviorprint feature vectors or other predicted outputs converge with expected behaviorprint feature vectors or other expected outputs indicated by the labels associated with the training contact data. When the training phase is completed, the server stores the hyper-parameters into a memory of the server or other memory location. The server may also disable one or more layers of the machine-learning architecture during later operational phases in order to keep the hyper-parameters fixed.

In operation 204, the server places the machine-learning architecture into an enrollment phase, and obtains enrollment contact data for an enrollee. The enrollment data includes enrollment keypress data in enrollment contact data of one or more enrollment contact events.

In operation 206, the server computes, extract, or otherwise generates enrollment keypress features using enrollment keypress data. Non-limiting examples of keypress features include keypress duration, keypress interval, keypress volume, or keypress selection sequence, among other types of keypress features. The server may store these keypress features and, optionally, any number of additional types of features and store the features as enrollment features associated with the enrollee in a database.

In operation 208, the server extracts an enrolled behaviorprint embedding vector for the enrollee based upon the plurality of enrollment keypress features of the enrollment contact event. For each enrollment contact data record, the server may extract an enrolled embedding as a feature vector using the behavior features, which includes one or more keypress features. The server then stores embedding feature vector into the database as the enrolled behaviorprint embedding vector for the enrollee. The server may compute an average or algorithmically combine multiple enrolled behaviorprint embedding vectors to update the enrolled behaviorprint embedding vector for the enrollee in the database.

In operation 210, the server places the machine-learning architecture into a deployment phase. At inference time, the server receives inbound contact data having inbound keypress data from a provider server or other device that captures keypress inputs from an inbound user, such as a computing device executing IVR software. The server generates a plurality of inbound keypress features corresponding to the enrollment keypress features using the inbound keypress data of an inbound contact event. The server may compute, extract, or otherwise generate the inbound keypress features using the inbound keypress data. Non-limiting examples include the duration, interval, volume, or keypress selection sequence, among others.

In operation 212, the server then extracts an inbound behaviorprint embedding vector for the inbound user based upon the plurality of inbound keypress features. The inbound behaviorprint embedding vector mathematically represents the inbound user's behavior pattern when interacting with a keypress interface.

In operation 214, the server computes one or more scores based upon a cosine distance between the inbound behaviorprint embedding vector and the enrolled behaviorprint embedding vector. The server authenticates the inbound user as the enrollee in accordance with an an authentication score. The server computes the authentication based upon the distance between the inbound behaviorprint embedding vector and the enrolled behaviorprint embedding vector. Additionally or alternatively, the server may perform risk scoring functions according to the cosine distance or other similarity measures outputted by classifier or clustering layers of the machine-learning architecture. As an example, in some embodiments, the server may perform various downstream operations for computing risk scoring, such as predicting an age or gender based upon the keypress pattern of the inbound behaviorprint embedding vector and comparing the predicted age or gender of the inbound user against the expected age or gender indicated by an enrolled user profile record in a database.

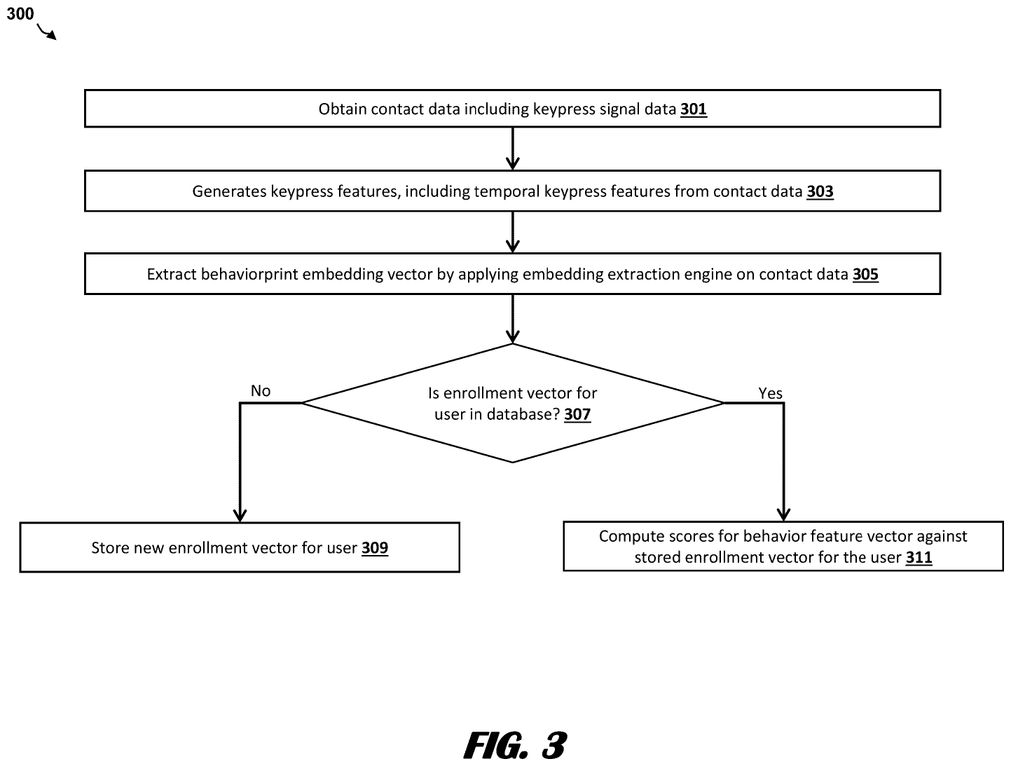

FIG. 3 shows operations of an example method 300 for deploying a machine-learning architecture for performing passive authentication and passive enrollment of behaviorprint embedding vectors. Embodiments may include additional, fewer, or different operations than those described in the method 300. The method 300 is performed by a server executing machine-readable software code of a neural network architecture comprising any number of neural network layers and neural networks, though the various operations may be performed by one or more computing devices and/or processors. Although the server is described as generating and evaluating enrollee embeddings, the server need not generate and evaluate the enrollee embeddings in all embodiments.

In operation 301, the server obtains inbound contact data including inbound keypress data representing inbound keypress features. In operation 303, the server extracts, computes, or otherwise generates the inbound keypress features, including the inbound temporal keypress features from the inbound contact data. In operation 305, the server extracts an inbound behaviorprint embedding vector for the inbound contact data using the contact data.

In determination 307, the server determines whether a database contains an instance of an enrolled behaviorprint embedding vector for an enrolled user who the end-user purports to be. If no, then in operation 309, the server may generate and store the inbound behaviorprint embedding vector as a new enrolled behaviorprint embedding vector for the current inbound end-user.

If yes, then in operation 311, the server may compute one or more scores (e.g., cosine distance, similarity score, authentication score) based upon a cosine distance or level of similarity between the inbound user's inbound behaviorprint embedding vectors and the stored enrolled user's enrolled behaviorprint embedding vectors. The server authenticates the inbound user as the enrolled user in response to determining that the one or more scores satisfy one or more authentication threshold.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
obtaining, by a computer, enrollment contact data for an enrollee including enrollment keypress data for an enrollment contact event;
generating, by the computer, a plurality of enrollment keypress features using the keypress data of the enrollment contact data, the plurality of enrollment keypress features including one or more temporal keypress features;
extracting, by a computer, an enrolled behaviorprint vector for the enrollee based upon the plurality of enrollment keypress features, including the one or more enrollment temporal keypress features;
generating, by the computer, a plurality of inbound keypress features using inbound keypress data of an inbound contact data, the plurality of inbound keypress features including one or more inbound temporal keypress features;
extracting, by a computer, an inbound behaviorprint vector for an inbound user based upon the plurality of inbound keypress features, including the one or more inbound temporal keypress features; and
authenticating, by the computer, the inbound user as the enrollee in accordance with an authentication score based upon a distance between the enrolled behaviorprint vector and the inbound behaviorprint vector.

2. The method according to claim 1, wherein a temporal keypress feature of the enrollment temporal keypress features or the inbound temporal keypress features includes at least one of a keypress duration or a keypress interval between successive keypress.

3. The method according to claim 1, further comprising obtaining, by the computer, inbound keypress data including the inbound keypress features for the inbound contact event via a set of one or more keypress responses corresponding to a set of one or more prompts of an interactive voice response program.

4. The method according to claim 3, wherein the keypress data is obtained as one or more dual-tone multi-frequency (DTMF) tones form the interactive voice response program.

5. The method according to claim 1, wherein the computer obtains the enrollment contact data for the enrollee including the enrollment keypress data for a plurality of enrollment contact events, and
wherein the computer extracts the enrolled behaviorprint vector for the enrollee based upon the plurality of enrollment keypress features for the plurality of enrollment contact data events.

6. The method according to claim 1, further comprising generating, by the computer, a predicted age for the inbound user based upon the inbound temporal keypress features, wherein the computer further authenticates the inbound user as the enrollee based upon comparing the predicted age for the inbound user and an expected age of the enrollee.

7. The method according to claim 1, further comprising generating, by the computer, a predicted gender for the inbound user based upon the inbound keypress features, wherein the computer further authenticates the inbound user as the enrollee based upon comparing the predicted gender for the inbound user and an expected gender of the enrollee.

8. The method according to claim 1, further comprising:
extracting, by a computer, a robocall behaviorprint vector associated with one or more robocalls based upon a plurality of robocall keypress features of a plurality of robocall contact events, including the one or more robocall temporal keypress features; and
generating, by the computer, a robocall prediction score associated with the inbound contact event based upon a distance between the inbound user behaviorprint vector and the robocall behaviorprint vector.

9. The method according to claim 8, wherein extracting the robocall behaviorprint vector includes obtaining, by the computer, a robocall label indicating that a prior contact event is a robocall contact event.

10. The method according to claim 1, further comprising:
obtaining, by a computer, training contact data for enrollment keypress data for a plurality of training contact events;
generating, by the computer, a plurality of training keypress features using the training keypress data of the training contact data, the plurality of training keypress features including one or more training temporal keypress features;
extracting, by a computer, an training behaviorprint vector for the training contact event based upon the plurality of training keypress features, including the one or more training temporal keypress features;
generating, by the computer, a predicted output score by applying a machine-learning architecture on the training behaviorprint; and
updating, by the computer, one or more hyperparmeters of the machine-learning architecture according to a loss function determined based upon a distance between the predicted output score and an expected output score.

11. A system comprising:
a computer comprising a processor configured to:
obtain enrollment contact data for an enrollee including enrollment keypress data for an enrollment contact event;
generate a plurality of enrollment keypress features using the enrollment keypress data of the enrollment contact data, the plurality of enrollment keypress features including one or more enrollment temporal keypress features;
extract an enrolled behaviorprint vector for the enrollee based upon the plurality of enrollment keypress features, including the one or more enrollment temporal keypress features;
generate a plurality of inbound keypress features using inbound keypress data of an inbound contact data, the plurality of inbound keypress features including one or more inbound temporal keypress features;
extract an inbound behaviorprint vector for an inbound user based upon the plurality of inbound keypress features, including the one or more inbound temporal keypress features; and
authenticate the inbound user as the enrollee in accordance with an authentication score based upon a distance between the enrolled behaviorprint vector and the inbound behaviorprint vector.

12. The system according to claim 11, wherein a temporal keypress feature of the enrollment temporal keypress features or the inbound temporal keypress features includes at least one of a keypress duration or a keypress interval between successive keypress.

13. The system according to claim 11, wherein the computer is further configured to obtain inbound keypress data including the inbound keypress features for the inbound contact event via a set of one or more keypress responses corresponding to a set of one or more prompts of an interactive voice response program.

14. The system according to claim 13, wherein the keypress data is obtained as one or more dual-tone multi-frequency (DTMF) tones form the interactive voice response program.

15. The system according to claim 11, wherein the computer obtains the enrollment contact data for the enrollee including the enrollment keypress data for a plurality of enrollment contact events, and
wherein the computer extracts the enrolled behaviorprint vector for the enrollee based upon the plurality of enrollment keypress features for the plurality of enrollment contact data events.

16. The system according to claim 11, wherein the computer is further configured to generate a predicted age for the inbound user based upon the inbound temporal keypress features, wherein the computer further authenticates the inbound user as the enrollee based upon comparing the predicted age for the inbound user and an expected age of the enrollee.

17. The system according to claim 11, wherein the computer is further configured to generate a predicted gender for the inbound user based upon the inbound keypress features, wherein the computer further authenticates the inbound user as the enrollee based upon comparing the predicted gender for the inbound user and an expected gender of the enrollee.

18. The system according to claim 11, wherein the computer is further configured to:
extract a robocall behaviorprint vector associated with one or more robocalls based upon a plurality of robocall keypress features of a plurality of robocall contact events, including the one or more robocall temporal keypress features; and
generate a robocall prediction score associated with the inbound contact event based upon a distance between the inbound user behaviorprint vector and the robocall behaviorprint vector.

19. The system according to claim 18, wherein when extracting the robocall behaviorprint vector the computer is further configured to obtain a robocall label indicating that a prior contact event is a robocall contact event.

20. The system according to claim 11, wherein the computer is further configured to:
obtain training contact data for enrollment keypress data for a plurality of training contact events;
generate a plurality of training keypress features using the training keypress data of the training contact data, the plurality of training keypress features including one or more training temporal keypress features;
extract an training behaviorprint vector for the training contact event based upon the plurality of training keypress features, including the one or more training temporal keypress features;
generate a predicted output score by applying a machine-learning architecture on the training behaviorprint; and
update one or more hyperparmeters of the machine-learning architecture according to a loss function determined based upon a distance between the predicted output score and an expected output score.
